(19) United States
(12) Patent Application Publication
(10) Pub. No.: US 2009/0236055 A1
(43) Pub. Date: Sep. 24, 2009

(54) FABRIC HOLDING VALANCE

(76) Inventor: Nancy L. Lasch, Cleveland, OH (US)

Correspondence Address: D.A. STAUFFER PATENT SERVICES LLC, 1006 MONTFORD ROAD, CLEVLAND HTS., OH, 44121-2016, US

(21) Appl. No.: 12/410,458

(22) Filed: Mar. 24, 2009

Related U.S. Application Data
(60) Provisional application No. 61/038,994, filed on Mar. 24, 2008.

(51) Int. Cl. E06B 9/00

(52) U.S. Cl. 160/368.1

(57) ABSTRACT

The inventive elongate panel comprises an inner bar and an outer bar, wherein the inner bar slides telescopingly within the outer bar for simple assembly and simple length adjustment to any length within a range while not requiring any cutting of a panel bar. A new bracket design is presented which slip-fits into the end return, thereby supporting the panel by its ends and simultaneously holding the curvature of the end return. A type of rounded (essentially single radius) bend at the corner of the end return is disclosed, wherein fabric can be applied before bending and a smoothly gathered fabric-covered curve will result from bending the panel at the inventive rounded bend. Simplified alternative shapes and constructions for the panel bars are presented.

### CROSS-REFERENCE TO RELATED APPLICATIONS

This application claims the benefit of U.S. Provisional Patent Application No. 61/038,994 filed Mar. 24, 2008 by Nancy L. Lasch, and incorporated herein in its entirety by reference.

The inventor Nancy L. Lasch is also a co-inventor of a previous invention, the “NO-SEW CORNICE” disclosed in Published US Patent Application US2003/0029822, Feb. 13, 2003 (application Ser. No. 10/192,473, later abandoned), and also hereby incorporated herein in its entirety by reference. This is done since it describes certain elements that are common to both of the prior art cornice and the present valance (a.k.a. cornice), the present inventive valance being improved over the prior art. Nancy L. Lasch alone is cited as an inventor for the purposes of the present filing because the improvements claimed as invention are solely her invention.

### BACKGROUND OF THE INVENTION

The invention and related apparatus is and has been referred to as a “valance” and/or a “cornice”. These terms are used herein with the intention that they refer to the same object. A dictionary definition and/or common use generally consider a panel across the top of a window as a window cornice or a cornice type of window valance or a cornice valance. There are different types of valances (e.g., a panel or draped fabric), that are used in different places (e.g., above a window or below a bed side rail). There are also different types of cornices (e.g., a decorative horizontal panel covering curtain rods, hooks, etc, or a decorative plaster or stone molding at the top of a wall). Thus either term can be used, and should be understood within the context that it is described. Thus the invention concerns a cornice type of valence which is in the general form of an elongated generally flat panel. Although it is described generally for use over a window, any other decorative use is considered entirely within the scope of the present invention.

Referring to the prior art document US2003/0029822, incorporated herein, a no-sew cornice is disclosed that includes a rigid hollow core or profile (5) that is covered with resilient foam (6, 7). The rigid profile provides a structure that allows the cornice to span wide distances without noticeable sagging. The rigid profile is also provided with slots (8) or channels corresponding to the edges of the foam covering that accept decorative fabrics or other materials. The resiliency and coefficient of friction of the foam provides sufficient grip to hold fabric or other materials to the device. Decorative articles can also be pinned to the foam. Fabric and/or other decorative articles can be tucked or wedged into a longitudinal slot between the two foam pieces that resiliently fill the slot.

The prior art device preferably comprised a single straight section (1), although multiple straight sections of the same length or different lengths could be used in order to incrementally adjust the width of the window treatment device to suit a particular application. Connectors (4 in PRIOR ART FIG. 1) could be utilized to join straight sections together. In an illustrated embodiment of the prior art, the connectors comprise rigid tabs that slide into receiving boxes (9 in PRIOR ART FIG. 2) on adjacent sections. However, the prior art states that it is preferable that the entire device be constructed of a single panel, which may be one continuous length, and may also include a means to form the end returns as shown in PRIOR ART FIGS. 5 and 6, i.e., transverse V-shaped notches (16).

The prior art also notes that the longitudinal slots (8) can be used to receive mounting brackets (11), such as shown in PRIOR ART FIG. 4.

Thus the prior art cornice is perceived to have several problems or deficiencies including the following:

The (prior art) profile/panel (5), whether provided as a single section or multiple joined sections, must be custom cut to fit a window width. Thus either a series of standard lengths must be stocked, or the vendor or the customer must cut the panel to a desired length, e.g., with a hacksaw. This may present problems for vendors and/or customers.

If the cornice is to be bent to form end returns, then there needs to be a way to hold it in a bent configuration. The prior art disclosure is silent about this and no reasonable solution is apparent. The proposed mounting bracket (11) only appears to be suitable for mounting a straight panel without end returns.

The illustrated end returns are “curved” by bending to collapse the V shaped notch(es) (16). This does not yield a smooth rounded curve at the corner; rather, as shown in PRIOR ART FIG. 1, there are two sharp bends where the foam puckers, and this in turn causes unsightly puckering of any fabric attached thereon.

Thus it is an object to improve the prior art to overcome defects such as these.

### BRIEF SUMMARY OF THE INVENTION

According to the invention the following novel features address one or more of the problems with the prior art cornice (valance).

1. The inventive elongate panel comprises an inner bar and an outer bar, wherein the inner bar slides telescopingly within the outer bar for simple assembly and simple length adjustment to any length within a range (e.g., 2 to 3 feet, 4 to 7 feet, etc.) while not requiring any cutting of a panel bar.

2. A new bracket design is presented which slip-fits into the end return, thereby supporting the panel by its ends and simultaneously holding the curvature of the end return.

3. A type of rounded (essentially single radius) bend at the corner of the end return is presented, wherein fabric can be applied before bending and a smoothly gathered fabric-covered curve will result from bending the panel at the inventive rounded bend.

4. Simplified alternative shapes and constructions for the panel bars are presented.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIGS. 1A and 1B are end views of an inventive telescoping valance bar comprising an outer bar, and an inner bar, according to the invention.

FIG. 2 is an end view of an assembled telescoping valance bar, according to the invention.

FIG. 3 is a perspective end view of an assembled telescoping valance bar with a foam layer applied in two pieces on each of the inner and outer bars, according to the invention.

FIGS. 4A and 4B show a side and edge view, respectively, of a valance bar with a bend joint, according to the invention.

FIG. 4C shows a magnified detail of the circled portion of FIG. 4B.

FIGS. 5A and 5B show two different scale edge views of the joint after bending to form an end return, according to the invention.

FIGS. 6A, 6B, and 6C are perspective views of user assembled parts of the telescoping valance, according to the invention.

FIG. 7 is a perspective view of a mounting bracket, according to the invention.

FIG. 8 is an end view of an alternative embodiment of the inner bar.

FIG. 9 is an exploded view of a prior art embodiment of a valance.

FIG. 10 is a cross-sectional view of an alternate embodiment of the valance bar according to the invention, and showing an alternate wall mounting means usable with the present invention.

### DETAILED DESCRIPTION OF THE INVENTION

The decorative window treatment device according to the present invention is primarily intended for use as a window cornice. However, the device may be used in other applications where a decorative fabric covered panel is desired such as, for example, a wall hanging.

Referring to FIG. 9, a prior art embodiment of a valance according to the previous work of the inventor, still shows elements that can be used in the present invention, as well as illustrating where the improvements will be. The prior art comprises a single straight section 1, although multiple straight sections of the same length or different lengths may be used in order to incrementally adjust the width of the window treatment device to suit a particular application. Connectors 4 can be utilized, if necessary, to join straight sections together. It will be appreciated that the configuration of the connectors 4 is not critical, and various types of connectors can be used. In this example, the connectors 4 comprise rigid tabs that slide into receiving boxes 9 on adjacent sections 1.

Although connectors 4 are useful for joining straight sections 1 together, it is preferable that the entire device be constructed of a single panel, which may be one continuous length, and may also include a means to form end returns 2. Alternately, as shown here, the end returns 2 may be joined to ends of the straight section 1 using the same connectors 4. It is noted that the prior art end returns 2 are shown with the prior art type of bend 3 that yields a puckered corner instead of a more desirable smoothly curving rounded corner which will be described hereinbelow as an improvement according to the present invention.

FIG. 10 is a cross-sectional view of an alternate embodiment of the valance bar according to the invention, this embodiment being the straight section disclosed in the prior application of the inventor. Although this illustration shows non-inventive prior art, it should be understood that inventive aspects of the present invention (disclosed hereinbelow) such as, for example, an inventive end return, can be used with this prior art, in which case the inventive end return may have the same cross-section where it joins the straight section.

The straight section 1 comprises an elongate rigid core 5 or profile having a layer of resilient material 6 and 7 such as foam adhered thereto. In a preferred embodiment, the foam material is provided in two elongated sheets of foam 6 and 7 whose edges are wrapped into slots or elongate channels 8 that are cut into the side of the elongate rigid core 5 and provide an opening to a first interior cavity. The foam may also have edges that butt against each other or be spaced apart slightly to form a gap. A single sheet of decorative material 10 such as fabric is shown wrapped around the foam 6 and 7 and tucked into the back side slot 8. The resiliency and frictional properties of the foam 6 and 7 grip the fabric and retain it in place. The fabric is generally not part of the valance. Rather it is supplied by the user in a variety of forms for decorating as they choose. Although the bar 1 can have only one channel 8, having two as illustrated allows for the use of two or more sheets of decorative material such as fabric 10, with each sheet covering a separate piece of foam 6 and 7. Thus, a window treatment device according to this embodiment of the invention facilitates the use of different fabrics or combinations of multiple fabrics for decorative purposes. Fabric may be allowed to hang from the slot to form a curtain or drape.

In addition to sheets of decorative material, other decorative objects can be tucked into the slot 8 on the front side of the window treatment device. These other decorative objects, such as tassels, cords, chains, buttons, pins, pendants, flowers, and other decorative objects, can hang from the window treatment device, rather than wrap the straight section 1 to provided additional decorative effects.

The elongate rigid core 5 is preferably formed of an extruded polymer material, preferably rigid vinyl or ABS plastic. It will be appreciated that other rigid materials such as, for example, aluminum, wood, and cellulose based materials, could also be used. The elongate rigid core 5 has a first elongate channel 8 or slot disposed on a rear side. The elongate channel forms a first opening into a rear interior cavity. In a preferred embodiment of the invention, the elongate rigid core or profile also includes an elongate channel or slot in the front side that defines an opening into a front interior cavity. The edge of a sheet of fabric 10 and/or other decorative material can be passed through an opening and into an interior cavity. The slots 8 can also be used to receive mounting brackets 11. The elongate rigid core 5 also preferably includes hollows or boxes 9 that receive connectors 4, as shown in FIG. 9. The shape of the elongate rigid core 5 is preferably the same front and back, which allows for easy assembly of multiple sections.

The mounting bracket 11 comprises another wall mounting means that is usable with the present invention. The mounting bracket 11 is shown inserted into the slot 8 between the ends of the fabric 10 in order to support the weight of the valance. The mounting bracket 11 preferably comprises a cornice back support 12, which is a tab or flange that extends down across the face of the rear side of the elongate rigid core to provide angular support to the cornice to maintain a vertical orientation of the cornice when mounted. It will be appreciated that other angles may be supported if desired. The mounting bracket 11 further comprises an end 13 for attachment to a wall or other vertical support structure. Preferably, the mounting bracket 11 is provided with slotted openings for fasteners 14 and 15, which allows for length adjustment.

The description hereinbelow will now focus on aspects of the inventive valance (cornice) that are new with respect to the prior art cornice described hereinabove and presented in the prior art publication that is incorporated for reference herein. Anything that is functionally equivalent to the prior art cornice will generally be assumed understood from the prior art description and therefore won't need redundant description hereinbelow. For instance, a foam lined longitudinal slot is used in both prior art and in the present invention for the same purpose of providing a place to secure decorative items such as fabric. The prior art slot and the present slot perform the same general fabric holding function even though they are shaped somewhat differently for reasons other than what is needed to hold the decorative items.

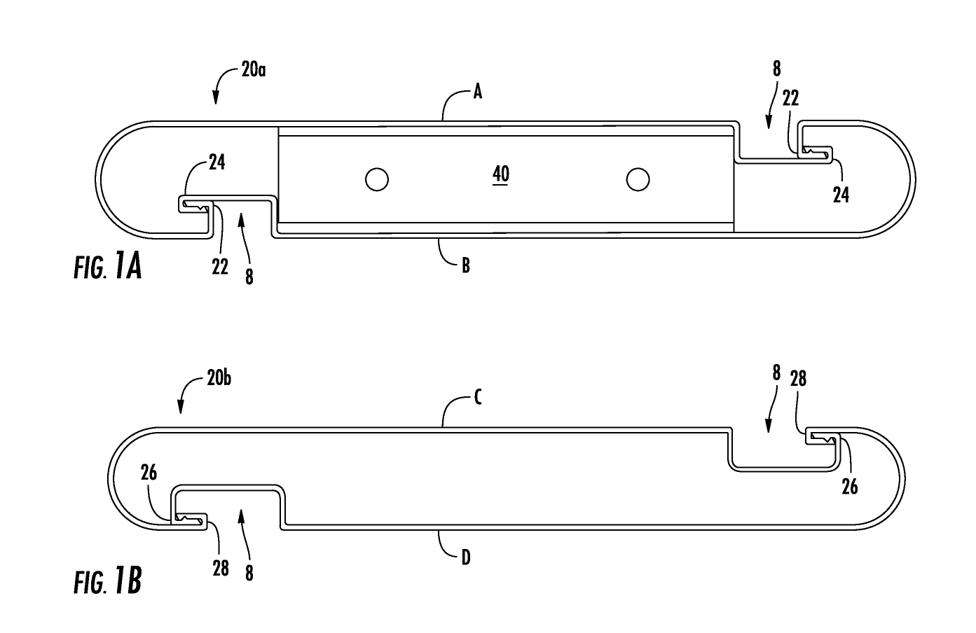

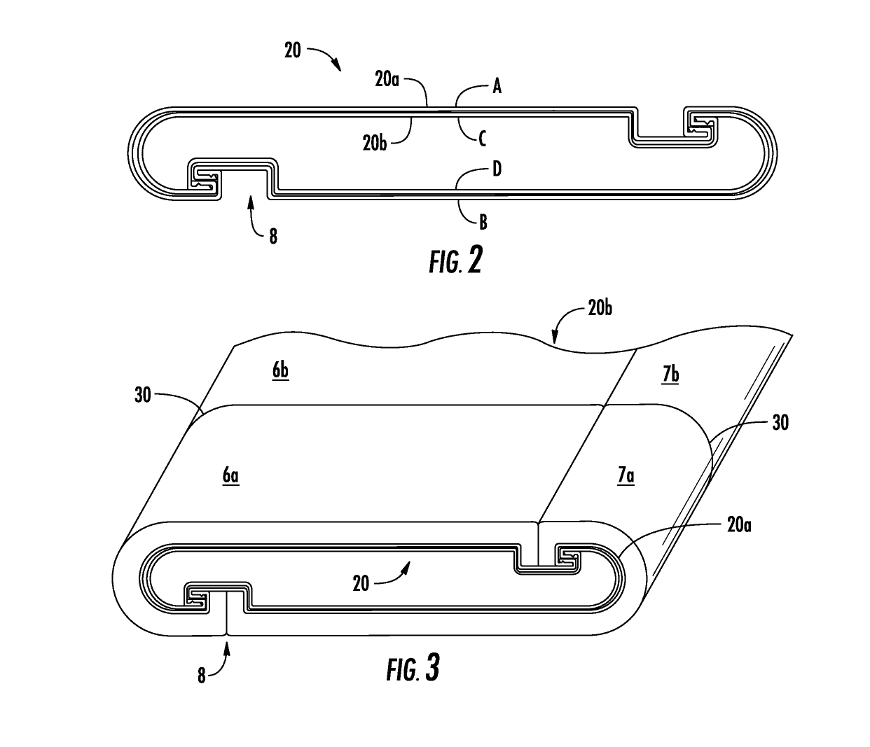

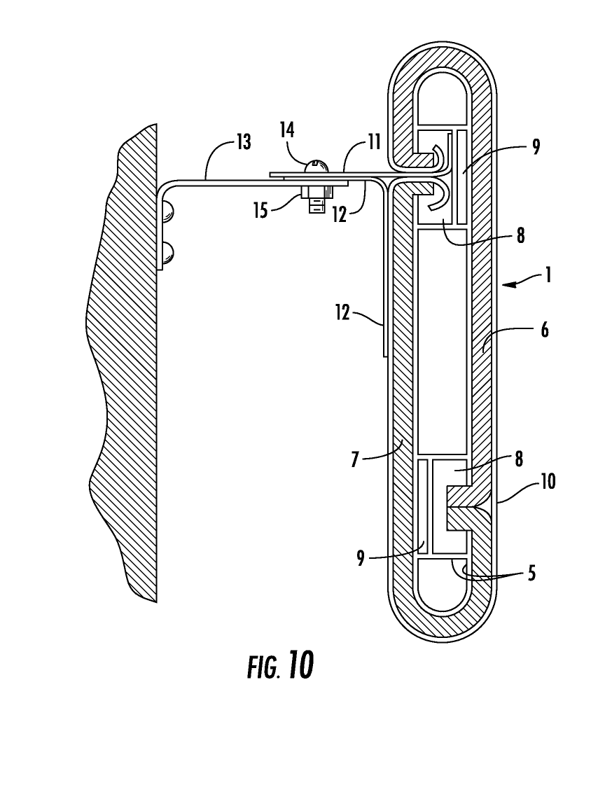

FIGS. 1A and 1B shows an inventive telescoping valance bar 20 comprising an outer bar 20a, and an inner bar 20b that is dimensioned such that it telescopingly slides within the outer bar 20a. Both bars are themselves two-piece assemblies: the first outer piece A being identical to the second outer piece B, and the first inner piece C being identical to the second inner piece D—all of which are easily thermo-formed from continuous ribbons of material (e.g., plastic). Piece B is flipped over relative to A, and tabs 22 are jamb-fit (e.g., held with a barbed edge as shown) and/or adhered in mating folds 24 to form joints as shown. The same process is used to assemble pieces C and D using inner tabs 26 and folds 28. Other than outside dimensions, the main difference in the two bars is in the positioning of the tab-in-fold joints 22/24 and 26/28: for the outer bar 20a they project into the bar interior but are spaced away from the outside flat surface; for the inner bar 20b they project into the slot area 8 and are level with the outside flat surface. These are complimentary shapes that will telescope as shown in FIG. 2. FIG. 8 shows an alternative embodiment of the inner bar 20b′ which can be extruded in a single piece, still much less complicated than the prior art extrusion.

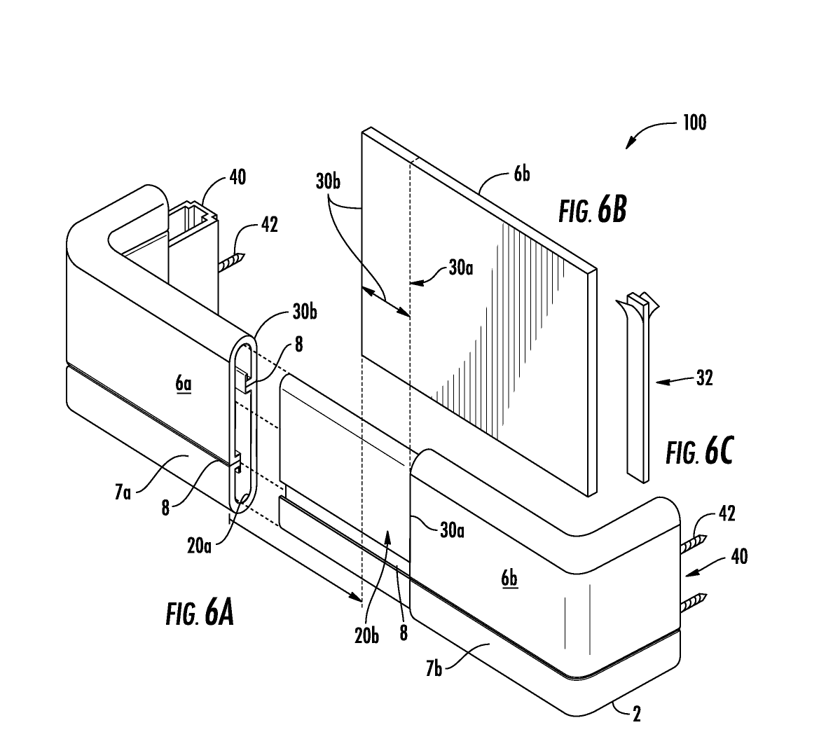

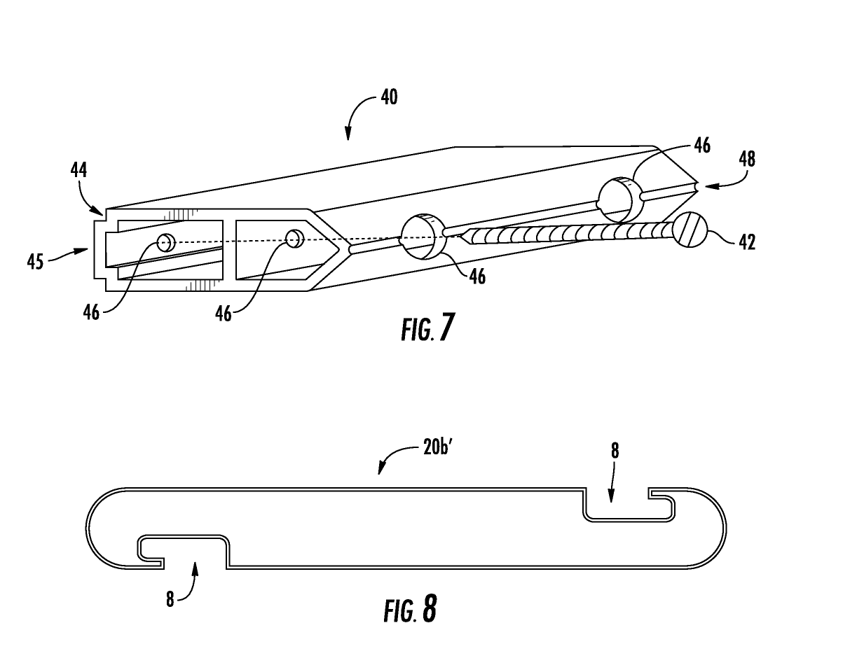

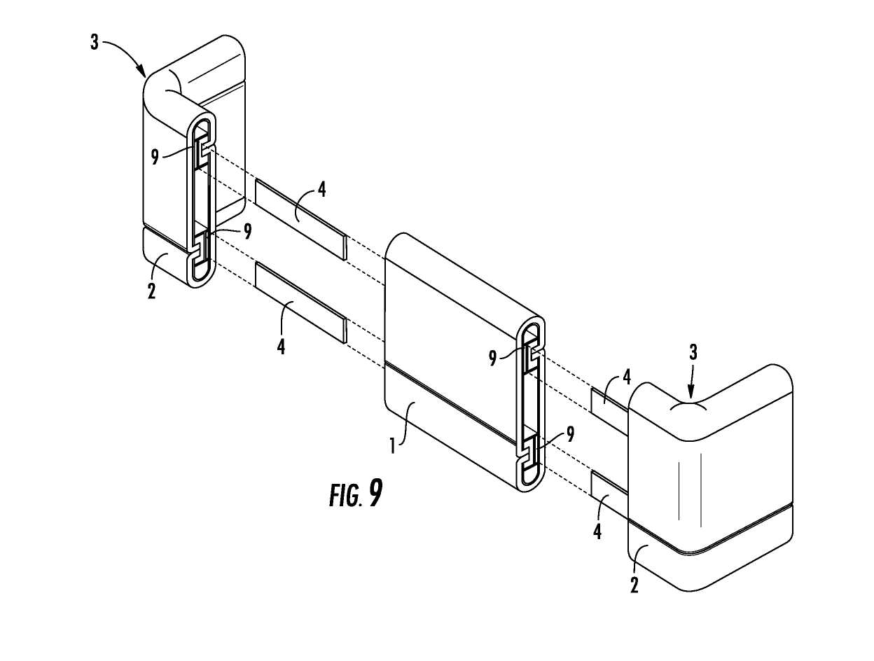

FIG. 3 shows the assembled telescoped bars 20 in perspective with a foam layer 6a and 7a applied on the outer bar 20a, and a foam layer 6b and 7b applied on the surface of the inner bar 20b where it extends beyond the end of the outer bar 20a (indicated by a cut line 30 between the foam pieces a and b. Referring also to FIGS. 6A-6C, the meaning of the “cut line” 30 becomes evident. In the preferred embodiment of the present invention, the outer bars 20a are supplied with the foam layers 6a and 7a already adhered on them (e.g., adhesive), but the inner bar 20b is supplied with separate foam pieces 6b and 7b plus adhesive 32 (e.g., double sided tape) for final assembly by the user. This is done so that the bare inner bar 20b will slide unhindered within the foam covered outer bar 20a while the user adjusts the telescoping valance 100 to a desired length (e.g., spanning the width of a window). Once adjusted, the foam pieces 6b and 7b can be cut with scissors to the exact length needed to cover just the exposed length of the inner bar, and then the two cut pieces of foam can be adhered to the inner bar 20b using supplied pieces of double stick tape 32, and the longitudinal edges of the cut foam pieces 6 and 7 can be tucked into the tuck slots 8. As with telescoping curtain rods, several inches of (bare) inner bar 20b must overlap within the outer bar 20a to prevent sagging or falling apart.

This inventive configuration gets around the prior art problems of stocking and custom cutting of the bar/panel(s) 1. Cutting foam with scissors and sticking it on with tape is much easier than hacksawing a rigid extrusion, and is well within the capabilities of anyone likely to use the valance 100 by covering it with fabric 10, for example. Stocking problems are greatly reduced since standardized length end pieces (left and right outer bars 20a) can be combined with a limited selection of telescoping inner bars 20b to allow custom (adjustable) lengths within a wide range of sizes. For example, allowing for at least 3″ (inch) telescopic overlap, then ends with 1 foot of length from the end return corner 2 can be combined with a 24″ inner bar 20b to allow adjustment from 24″ to 42″ (12end-3overlap+12-3+24 inner). For example, substituting a 42″ inner bar allows adjustment from 42″ to 60″. Thus stocking of one end piece and two different length inner bars will satisfy orders for any custom length from 24″ to 60″. These could be stocked as two kits: each having two end pieces 20a, two support brackets 40 with screws 42, and either the 24″ or 42″ inner bar 20b with accompanying foam pieces 6b and 7b plus adequate number of double stick tape pieces 32. The two foam pieces could be the correct width for wrapping and tucking, and 6″ shorter in length than the corresponding inner bar.

FIGS. 1A, 6A, and 7 also show an inventive mounting bracket 40 and how it is used. Using two screws 42 through holes 46, the bracket 40 is attached to a supporting surface (e.g., the wall next to the window frame) and then a valance end return 2 is slip-fit over the bracket 40.

FIG. 1A shows that the bracket 40 (screws omitted) fits snugly to fill the space between front and back walls and left and right slots 8 inside the bar 20. It can be seen that this arrangement provides vertical support while also preventing spreading (unbending) of the end returns 2. A beveled front edge 48 helps guide the bracket 40 into the end return portion 2 of the bar 20. It should be apparent that other forms of this bracket could function similarly to serve the same purpose; for example, a squared-U shaped metal bracket with the bottom of the U being the base 45 that is screwed to the wall. Preferably the base 45 of the bracket 40 has an undercut portion 44 which can be used to wrap fabric 10 around the end of the end return 2 and tuck it in the undercut 44 for holding against the wall, thus hiding a raw fabric edge.

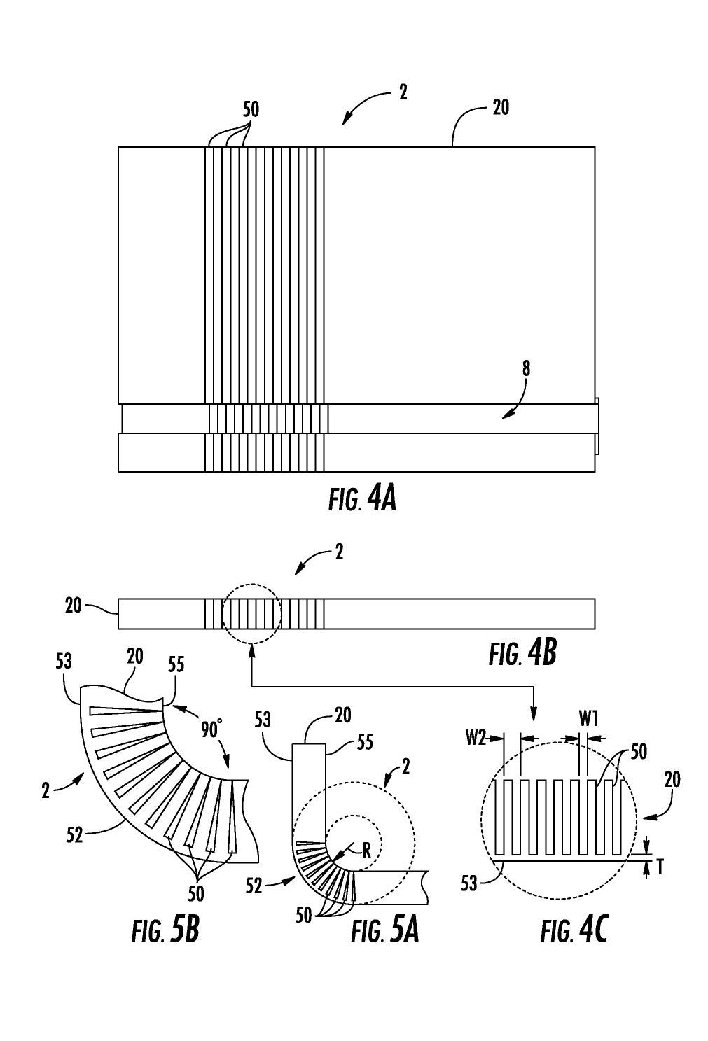

To solve the problem of puckering fabric at the end return 2 bends, the present inventor has conceived an improved type of bend 52 (flex joint) wherein the outer surface 53 of the bend 52 does not change circumferential length while the joint 52 is being bent, and the inner surface 55 of the bend 52 shrinks in circumference uniformly and smoothly as the joint 52 is being bent, and each surface will automatically form a single radius curve, when the joint 52 is bent approximately ninety degrees. In other words, the inner surface 55 of the joint changes from a straight line to a circular arc having a first single radius R, and the outer surface of the joint changes from a straight line to a circular arc having a second single radius, greater than the first radius R as determined by the thickness of the panel 20. The inventor determined that a flex joint 52 meeting these criteria will create a uniformly accordioned curve in the fabric 10 covering on the inner surface 55 of the joint 52, and a uniformly curved outer fabric surface that isn't distorted because the fabric 10 will not be stretched by the bending procedure. A flex joint meeting the inventive criteria is easily obtained by applying a well known technique of using a series of kerf cuts 50 as illustrated in FIGS. 4A-5B. A series of parallel saw kerfs 50 are cut across one side of a panel 20, with a depth reaching all the way to the inside surface of the opposite side 53 of the panel. A constant radius bend will be enabled as long as the kerfs are of uniform width W1 and uniform spacing W2 apart. Given the right number of kerfs of the right width and spaced apart the right amount, a constant radius right angle (90°) corner will result. Experimentation with a one inch thick prototype panel 20 has determined that 15 kerfs of ⅛″ width and ¼″ spacing is about “right”. This may need some adjustment when the final panel design is produced, but these exemplary dimensions should be an adequate guide for a designer of ordinary skill.

Although the three piece valance 100 as described hereinabove is a preferred embodiment, the scope of the present invention also includes a two piece version more like a simple curtain rod wherein a single inner bar 20b telescopingly slides within a single outer bar 20a, each of which has been saw cut to produce a flexible corner joint 52 thereby creating an end return 20.

Furthermore, several new aspects and features have been disclosed herein, and it should be understood that a claim to invention may include any single one of the new features, as well as various combinations thereof. Thus, for example, an inventive claim could be made to the rounded end-return corner itself, as applied to any structurally equivalent fabric holding valance, said valance potentially including a prior art valance—even one that is a single elongated panel configured to be a fabric holding valance. For example, the valance could be a panel 20 made of rigid foam.

Thus the present invention can be entitled an: EXTENDABLE, FLEXIBLE FABRIC HOLDING VALANCE. The extendable feature has been described as an inner bar telescopically engaged with one or two outer bars. The flexible part is the new joint that produces a nicely rounded corner 52 for an end return 2. The fabric holding valance is comparable to the prior art “no-sew cornice” wherein “fabric holding” is understood to include the ability to hold a variety of decorative items not limited to fabric.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A valance comprising:
an elongated panel;
an end return being an end of the panel that is a flexible joint capable of curving 90 degrees toward a mounting surface; wherein:
the joint comprises a series of kerf cuts perpendicular to the length direction of the panel, the cuts being of uniform width and uniform spacing.
